(19) United States
(12) Patent Application Publication
(10) Pub. No.: US 2011/0120235 A1
(43) Pub. Date: May 26, 2011

(54) ELASTIC BODY FOR MEASURING LOADS AND A NON-CONTACT LOAD-MEASURING DEVICE USING THE SAME

(76) Inventors: Dong-Ryong Shin, Gyeonggi-do (KR); Youn-Sok Lee, Gyeonggi-do (KR)

(21) Appl. No.: 12/991,538

(22) PCT Filed: May 11, 2009
(86) PCT No.: PCT/KR2009/002477

§ 371 Date: Dec. 21, 2010

(30) Foreign Application Priority Data
May 9, 2008 (KR) 10-2008-0043582

(51) Int. Cl. G01L 1/04

(52) U.S. Cl. 73/862.636

(57) ABSTRACT

An elastic body for measuring loads and a non-contact load-measuring device are disclosed. The elastic body includes: an elastic body base; a multiple number of slits formed in the elastic body base; and a deforming space part formed in the elastic body base. Inside the deforming space part are formed: a hinge, a first deforming part coupled with the hinge, and a second deforming part that is coupled with the first deforming part and the hinge and is formed with a greater length than that of the first deforming part. The first deforming part and second deforming part are configured to undergo rotational movements about the hinge in correspondence to the load, the first deforming part moving downwards in correspondence to the load and the second deforming part moving upwards in correspondence to the load. The upward displacement of the second deforming part is used for measuring the load.

### TECHNICAL FIELD

The present invention relates to an elastic body for measuring loads and to a non-contact load-measuring device using the same. More particularly, the invention relates to an elastic body and a load-measuring device with which the precision for measuring load can be improved.

### BACKGROUND ART

In the related art, the load cell is often used as a load-measuring device. FIG. 1 is a cross-sectional view of a load cell according to the related art, and FIG. 2 shows a top plan view (a) and a bottom plan view (b) of a load cell according to the related art.

Referring to FIG. 1, on the upper and lower portions of a cantilever type elastic body, strain gauges 10, 12, 14, 16 may be attached using a polymer adhesive. The strain gauges may be electrically connected, and when a load is applied, the strain gauges may be deformed in correspondence to the deformation of the elastic body.

FIG. 3 illustrates the changes that may occur when a load is applied on a load cell according to the related art.

Referring to FIG. 3, the cantilever type elastic body may undergo a deformation when a load is applied, and accordingly, the strain gauges 10, 12, 14, 16 attached to the elastic body may also be deformed.

As described above, the strain gauges 10, 12, 14, 16 may be electrically connected with one another. FIG. 4 illustrates the connections between the strain gauges as represented by a circuit.

Referring to FIG. 4, the strain gauges may be connected in the manner of a Wheatstone bridge, and when there is equilibrium, the output voltage is 0. That is, the strain gauges 10, 12, 14, 16 may act as resistance components in the circuit.

When a load is applied, the strain gauges attached to the elastic body may expand or contract. Since resistance is changed according to the cross-sectional area and length of the wire, the expansion or contraction of a strain gauge alters the resistance value of the strain gauge. As the resistance values are changed, the equilibrium of the Wheatstone bridge circuit is broken.

In this way, an output value may be generated in the Wheatstone bridge of FIG. 4, and by measuring the electrical output value generated when a load is applied, the load applied on the elastic body can be measured.

The strain gauges may be attached with adhesive, but the adhesive may distort the rate of deformation of the elastic body, and its non-crystalline composition may cause unevenness in the mechanical properties.

Also, since the strain gauges themselves may experience changes in their deformation properties as they repeatedly undergo expansion and contraction, prolonged use may result in lower precision.

In an attempt to resolve these problems in contact-based load measuring by strain gauges, the inventors of the present application have proposed a non-contact load-measuring device in Korean registered patent No. 589228.

FIG. 5 is an exploded perspective view of a non-contact load-measuring device according to the related art, and FIG. 6 is a cross-sectional view of a non-contact load-measuring device according to the related art.

Referring to FIG. 5 and FIG. 6, the load-measuring device according to the related art may include an elastic body 60, a side wall 62, and a lower surface 72. The object of which the load is being measured may be placed on the elastic body 60, which can be made of an elastic material such as aluminum and steel.

Two boards 66, 68 may be included inside the load-measuring device. Referring to FIG. 6, a first board 66 may be coupled to the lower surface of the load-measuring device, while a second board 68 may be coupled to a lower surface of the elastic body 60.

The first board 66 and second board 68 may have electrical patterns formed thereon. The first board 66, as it is coupled to the fixed lower surface, is positioned immovably, whereas the second board 68, which is coupled to the lower surface of the elastic body, may have its position changed in correspondence with the deformation of the elastic body when a load is applied. When the elastic body 60 is deformed by a load, the second board 68 may move downwards.

To either the first board 66 or the second board 68, an alternating current may be provided. If, for example, an alternating current is provided to the pattern on the first board 66, an induced current may be generated in the pattern of the second board due to electromagnetic induction, when the second board is moved downwards by a load. If, for example, an alternating current is provided to the pattern on the second board 68, an induced current may be generated in the pattern of the first board 66 due to electromagnetic induction, when the second board is moved downwards by a load.

The non-contact load-measuring device disclosed in Korean registered patent No. 589228 can measure loads without contact using the induced current generated by electromagnetic induction as described above. The non-contact load-measuring device according to the related art is thus able to resolve the drawback of reduced precision in conventional strain gauges.

In this type of non-contact load-measuring device, however, the actual degree of precision still depends on the deformation of the elastic body, and when the same elastic body is used, it is difficult to further increase precision.

### DISCLOSURE

### Technical Problem

To resolve the problems in the related art such as those described above, an aspect of the present invention proposes a non-contact load-measuring device that can improve precision in measuring loads.

Another objective of the present invention is to provide a non-contact load-measuring device that can measure loads with a higher degree of precision compared to the amount of deformation in the elastic body, using the principle of leverage.

Other objectives of the present invention can be readily deduced by those skilled in the art from the embodiments described below.

### Technical Solution

To achieve the objectives above, an aspect of the present invention provides an elastic body for measuring a load. The elastic body includes: an elastic body base; a multiple number of slits formed in the elastic body base; and a deforming space part formed in the elastic body base. Inside the deforming space part are formed: a hinge, a first deforming part that is coupled with the hinge, and a second deforming part that is coupled with the first deforming part and the hinge and is formed with a greater length than that of the first deforming part. The first deforming part and the second deforming part are configured to undergo rotational movements about the hinge in correspondence to the load, the first deforming part configured to move downwards in correspondence to the load and the second deforming part configured to move upwards in correspondence to the load. The upward displacement of the second deforming part is used for measuring the load.

The deforming space part may be a hole formed in the elastic body base, and the hinge, the first deforming part, and the second deforming part may be formed inside the hole.

The slits may be formed in the elastic body base along a horizontal direction, and a first slit may be included that causes a deformation of the elastic body not to be provided to the hinge when the load is applied.

The slits may include a second slit that extends vertically from the first slit.

The slits may include a third slit that is separated from the second slit by a particular distance and is formed vertically on the elastic body base.

The second slit and third slit may be deformed in correspondence to the load, when the load is applied, and may define a load transferring part that transfers the load to the first deforming part.

The load transferring part may move downward in correspondence to the load and may be deformed to be perpendicular to the first deforming part.

The second slit can have rounded structures at both ends.

Indentations may be formed in portions of the second slit, the third slit, and the load transferring part defined by the second slit and the third slit.

A hole can be formed in a lower end of the third slit.

Another aspect of the present invention provides a load-measuring device that includes: an elastic body; an arm; a first board; and a second board. The elastic body includes a multiple number of slits and a deforming space part formed therein. Inside the deforming space part are formed a hinge, a first deforming part, and a second deforming part, where the first deforming part is coupled with the hinge, and the second deforming part is coupled with the first deforming part and the hinge and has a greater length than that of the first deforming part. The first deforming part and the second deforming part are configured to undergo rotational movements about the hinge in correspondence to a load, with the first deforming part configured to move downwards in correspondence to the load and the second deforming part configured to move upwards in correspondence to the load. The arm is coupled with the second deforming part of the elastic body along a lengthwise direction of the second deforming part, the first board is coupled to an end portion of the arm, and the second board is coupled to a securing element. Electrical patterns are formed on the first board and the second board, and the load is measured using an induced current generated in an electrical pattern formed on one of the first board and the second board in correspondence to a movement of the first board.

### Advantageous Effects

Certain aspects of the present invention make it possible to improve the precision of the non-contact load-measuring device in measuring loads, and using the principle of leverage, to obtain the measurements with a higher degree of precision compared to the amount of deformation of the elastic body.

### DESCRIPTION OF DRAWINGS

FIG. 1 is a cross-sectional view of a load cell according to the related art.

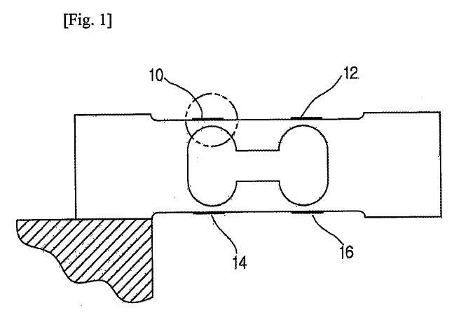

FIG. 2 shows a top plan view (a) and a bottom plan view (b) of a load cell according to the related art.

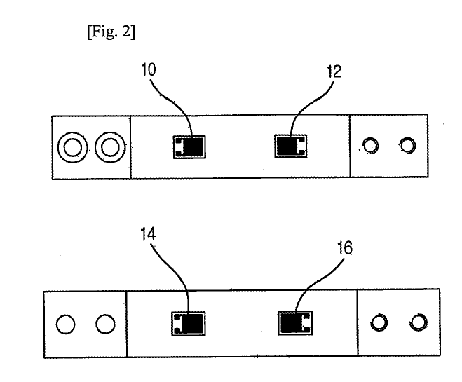

FIG. 3 illustrates changes that occur when a load is applied on a load cell according to the related art.

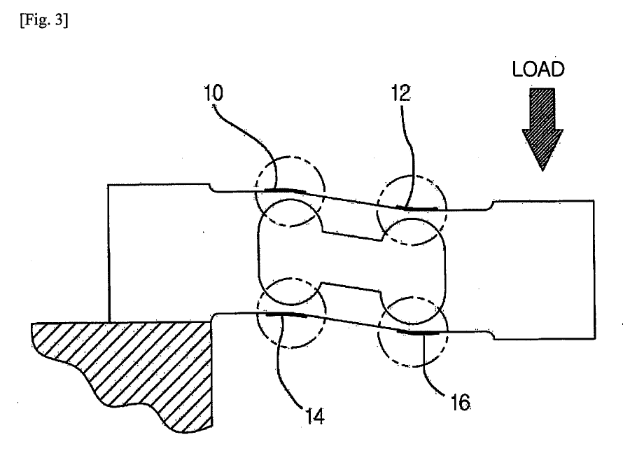

FIG. 4 illustrates the connections between strain gauges as represented by a circuit.

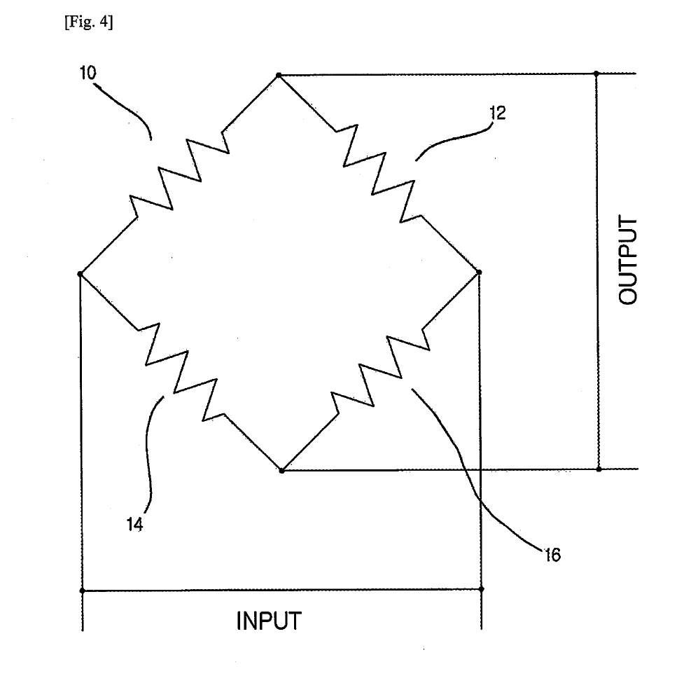

FIG. 5 is an exploded perspective view of a non-contact load-measuring device according to the related art.

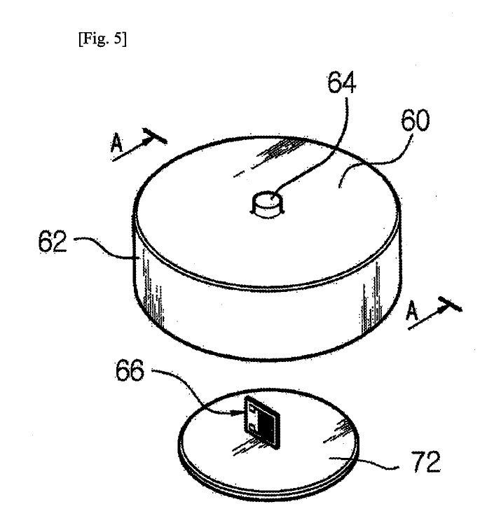

FIG. 6 is a cross-sectional view of a non-contact load-measuring device according to the related art.

FIG. 7 is a perspective view of an elastic body for a non-contact load-measuring device according to an embodiment of the present invention.

FIG. 8 is a front elevational view of an elastic body for a non-contact load-measuring device according to an embodiment of the present invention.

FIG. 9 illustrates the structure of a lever to better explain the principles of the present invention.

FIG. 10 illustrates the arrangement of FIG. 7 after the elastic body is deformed by a load.

FIG. 11 is a front elevational view of an elastic body for a non-contact load-measuring device according to another embodiment of the present invention.

FIG. 12 illustrates a non-contact load-measuring device according to an embodiment of the present invention when a load is applied.

FIG. 13 illustrates a load-measuring device in which an electric signal converter part for converting the deformation of an elastic body into an electrical signal is coupled to an elastic body according to an embodiment of the present invention.

FIG. 14 illustrates patterns formed on boards according to an embodiment of the present invention.

FIG. 15 illustrates position changes in the patterns formed on the first board and second board when a load is applied on a cantilever type elastic body according to an embodiment of the present invention.

FIG. 16 is a block diagram representing the composition of a signal processing part according to an embodiment of the present invention.

### MODE FOR INVENTION

The elastic body for measuring loads and the non-contact load-measuring device according to certain preferred embodiments of the present invention will be described below in more detail with reference to the accompanying drawings.

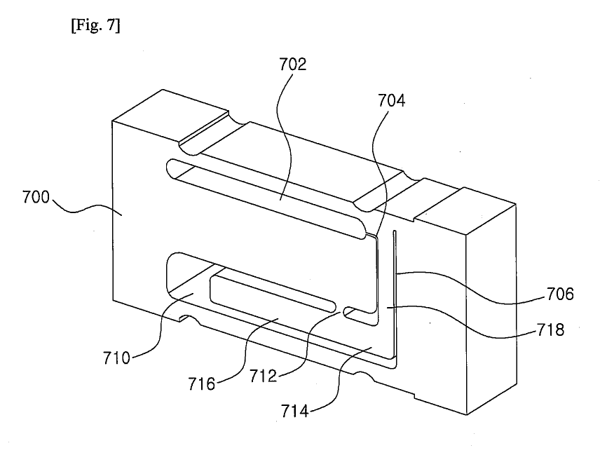

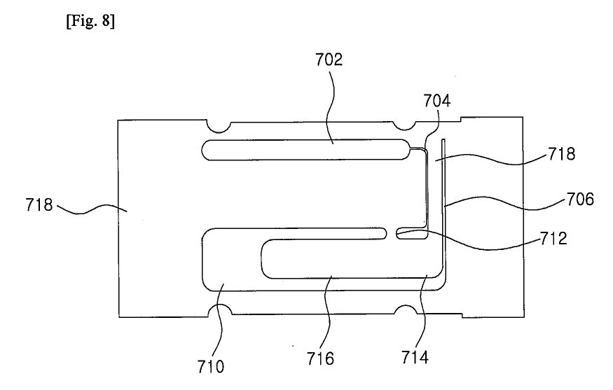

FIG. 7 is a perspective view of an elastic body for a non-contact load-measuring device according to an embodiment of the present invention, and FIG. 8 is a front elevational view of an elastic body for a non-contact load-measuring device according to an embodiment of the present invention.

Referring to FIG. 7, a non-contact load-measuring device according to an embodiment of the present invention may include an elastic body base 700, a first slit 702, a second slit 704, a third slit 706, and a deforming space part 710. Furthermore, inside the deforming space part 710, there may be formed a hinge 712, a first deforming part 714, and a second deforming part 716.

In FIG. 7, the object of the load-measuring may be placed on the upper right portion, and the elastic body base 700 may be deformed in correspondence to the object. The elastic body base 700 can have a generally cuboidal shape.

In FIG. 7, the first slit 702 may be formed along a horizontal direction in an upper area of the side of the elastic body base and may have a particular width. The width of the first slit 702 may be selected according to the amount of deformation of the elastic body. If the amount of deformation of the elastic body base is larger, then the first slit 702 can be wider, and if the amount of deformation of the elastic body base is smaller, then the first slit 702 can be narrower.

The first slit 702 may serve to prevent the deformation of the elastic body from being transferred below the first slit.

The second slit 704 may extend from the first slit 702 and may be formed along a generally perpendicular direction to that of the first slit 702.

The second slit 704, together with the third slit 706, may define a load transferring part 718. The third slit 706 may be separated from the second slit by a particular distance and may be formed along a vertical direction.

When the object of the load-measuring is placed, the load transferring part 718 may be deformed in correspondence to the load of the object.

The hinge 712, the first deforming part 714, and the second deforming part 716 may be formed inside the deforming space part 710. The first deforming part 714 and second deforming part 716 may be a single structure. For example, in FIG. 8, the portion to the right of the hinge 712 is the first deforming part 714, while the portion to the left of the hinge is the second deforming part 716. The first deforming part 714 may extend from the load transferring part.

The deforming space part 710 may provide the space within which the second deforming part 716 may be deformed when a load is applied.

The hinge 712 may perform substantially the same role as a hinge in a lever arrangement. When a load is applied, the first deforming part 714 and second deforming part 716 may undergo rotational movements about the hinge.

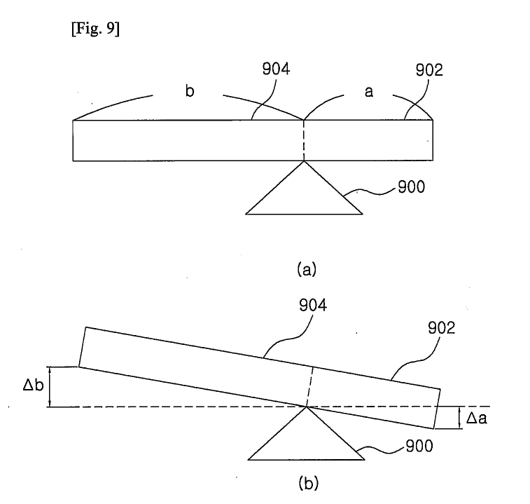

FIG. 9 illustrates the structure of a lever to better explain the principles of the present invention.

Referring to FIG. 9, a typical lever may include a hinge 900, a first deforming end 902, and a second deforming end 904.

When a load is applied on the first deforming end 902, the first deforming end 902 may move downwards, while the second deforming end 904 may move upwards correspondingly. By the principle of leverage, if the first deforming end 902 moves down by Δa, then the second deforming end 904 moves up by Δb, where the ratio between Δa and Δb corresponds to the ratio between the lengths a and b. The longer b is compared to a, the greater the length of Δb compared to Δa.

In the non-contact load-measuring device illustrated in FIG. 7 and FIG. 8, the first deforming part 714 corresponds to the first deforming end 902 of the lever, the second deforming part 716 corresponds to the second deforming end 904 of the lever, and the hinge 712 corresponds to the hinge 900 of the lever.

In FIG. 7, the end portion of the first deforming part 714 that is coupled with the load transferring part 718 may move downward in a rotational movement when a load is applied.

Conversely, the end portion of the second deforming part 716 on the left side of the hinge 712 may move upward while rotating about the hinge.

The downward displacement of the first deforming part 714 and the upward displacement of the second deforming part 716 may vary depending on the lengths of the first deforming part 714 and the second deforming part 716.

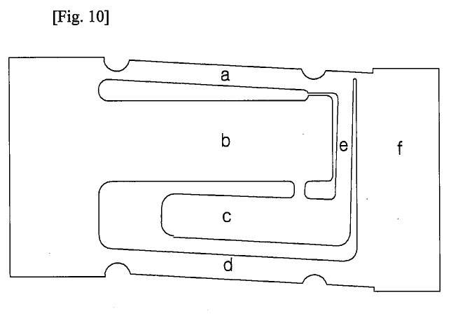

FIG. 10 illustrates the arrangement of FIG. 7 after the elastic body is deformed by a load.

Referring to FIG. 10, when a load is applied, the “a” portion of the elastic body base may bend and deform. However, the “b” portion below the first slit 702 may not deform, due to the first slit 702 and the second slit 704. On the other hand, portion “d”, which is the bottom portion of the elastic body, may also bend and deform.

When a load is applied, the “f” portion of the elastic body base may move downwards and be deformed. The “e” portion, which corresponds to the load transferring part 718, may transfer the downward force caused by the application of the load to the first deforming part 714, which is coupled to the hinge 712.

The first deforming part 714 and the second deforming part 716, i.e. the “c” portion, may then undergo rotational movements about the hinge 712. The “e” portion, which corresponds to the load transferring part, may be deformed such that it is perpendicular to the first deforming part. While the “f” portion may undergo a simple downward movement when a load is applied, the “e” portion can maintain a perpendicular orientation in relation to the first deforming part as it moves downward, due to the third slit.

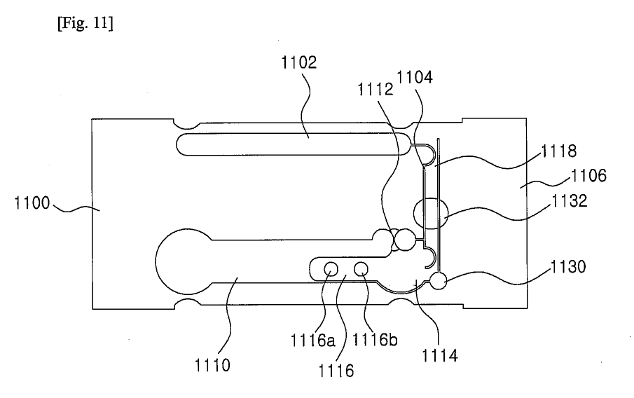

FIG. 11 is a front elevational view of an elastic body for a non-contact load-measuring device according to another embodiment of the present invention.

Referring to FIG. 11, the elastic body of a non-contact load-measuring device according to another embodiment of the invention can include an elastic body base 1100, a first slit 1102, a second slit 1104, a third slit 1106, and a deforming space part 1110, with a hinge 1112, a first deforming part 1114, and a second deforming part 1116 formed inside the deforming space part 1110.

Referring to FIG. 11, when the elastic body undergoes deformation, the first slit 1102 may prevent the bending from being transferred below the first slit. Because of the first slit 1102, the portions above the first slit may be deformed, but the portions below may not be deformed.

The second slit 1104 may extend vertically from the first slit 1102. Compared to the embodiment illustrated in FIG. 7 and FIG. 8, the second slit 1104 here has a rounded structure applied to the beginning and end portions. This rounded structure is to create more deformation when a load is applied.

Together with the third slit 1106, the second slit 1104 may define a load transferring part 1118.

The third slit 1106 may be formed vertically on the elastic body base, and at the end of the third slit 1106, a hole 1130 may be formed.

When the object of which the load is being measured is placed, the load transferring part 1118 may be deformed in correspondence to the load of the object, with the amount of deformation corresponding with the load. The hole 1130 at the end of the third slit 1106 may increase the amount of deformation of the load transferring part 1118 and thereby improve precision.

An indentation 1132 may be formed in the middle of the second slit 1104, the third slit 1106, and the load transferring part, where the indentation 1132 may also increase the deformation of the load transferring part 1118 and improve precision.

The hinge 1112, the first deforming part 1114, and the second deforming part 1116 may be formed inside the deforming space part 1110. The first deforming part 1114 and the second deforming part 1116 may be a single structure, and in the example shown in FIG. 11, the portion to the right of the hinge 1112 is the first deforming part 1114, and the portion to the left of the hinge is the second deforming part 1116.

The end portion of the first deforming part 1114 may be coupled with the load transferring part 1118 and may be moved downwards when a load is applied.

The hinge 1112 may cause the first deforming part 1114 and the second deforming part 1116 to undergo rotational movements when a load is applied, similar to the embodiment illustrated in FIG. 7.

The end portion of the second deforming part 1116, which is formed on the left of the hinge 1112, may move upwards in correspondence to the downward movement of the first deforming part 1114 because of the rotational movement. As described above, the upward displacement of the end portion of the second deforming part 1116 corresponds with the ratio between the lengths of the first deforming part 1114 and the second deforming part 1116.

Holes 1116a, 1116b can be formed in the second deforming part 1116. These holes 1116a, 1116b may be used to couple on the arm, which will be described later in more detail.

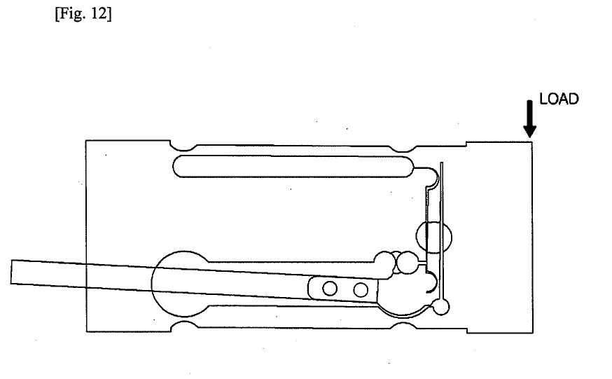

FIG. 12 illustrates a non-contact load-measuring device according to an embodiment of the present invention when a load is applied.

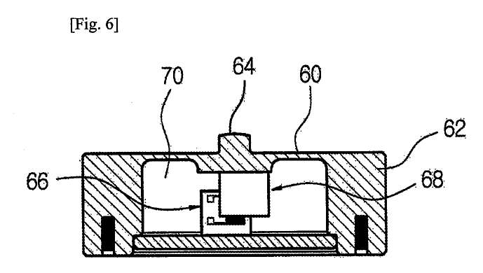

For a non-contact load-measuring device according to the related art, such as that illustrated in FIG. 6, the precision may be determined by the downward displacement corresponding to the load, and when using the same elastic body, it is difficult to further increase precision.

With a non-contact load-measuring device based on an embodiment of the invention, however, it is possible to perform the measuring with greater precision compared to the elasticity of the elastic body, by forming several slits and the deforming space part in the elastic body and by applying the principle of leverage to the load-measuring device.

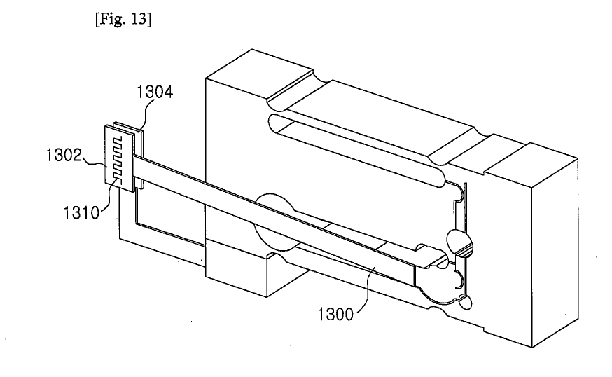

FIG. 13 illustrates a load-measuring device in which an electric signal converter part for converting the deformation of an elastic body into an electrical signal is coupled to an elastic body according to an embodiment of the present invention.

Referring to FIG. 13, an electric signal converter part according to an embodiment of the present invention can include an arm 1300, a first board 1302, and a second board 1304.

The first board 1302 can include an electric pattern, i.e. a first pattern 1310, formed thereon, while the second board 1304 can include an electric pattern, i.e. a first pattern (not shown), formed thereon.

The arm 1300 can be coupled by way of the holes 1116a, 1116b of the second deforming part, and various coupling methods can be used.

The arm 1300 may substantially increase the length of the second deforming part 1116 and thus amplify the upward displacement caused by the downward movement of the first deforming part.

The first board 1302 may be coupled with the arm 1300. When a load is applied on the elastic body, causing the second deforming part 1116 to move upward, the arm 1300 may move upward in correspondence to the movement of the second deforming part 1116.

As the arm 1300 moves upward, the first board 1302 coupled with the arm 1300 may also move upward.

Conversely, the second board 1304 may be affixed independently of the first board 1302. According to an embodiment of the present invention, the second board 1304 can be immovably connected to a support 1320 that carries the elastic body. Thus, when a load is applied, the first board may move upward, but the second board may be kept still.

One of the first pattern 1310 of the first board 1302 and the second pattern of the second board 1304 may be provided with an alternating current, while the other may not be provided with an alternating current.

When a load is applied on the elastic body so that the first board 1302 is moved upward, an induced current may be generated in the pattern to which an alternating current is not provided. For example, if an alternating current is provided to the first pattern 1310 of the first board 1302 and no alternating current is provided to the second pattern of the second board 1304, then as the first board 1302 moves upward due to the load, an induced current is generated in the second pattern of the second board 1304. The induced current corresponds with the upward displacement of the first board.

As already described above, when using an elastic body according to an embodiment of the present invention, the deformation of the elastic body can be amplified using the principle of leverage, so that the displacement of the first board resulting from the load can also be amplified, and the load-measuring can be performed with greater precision.

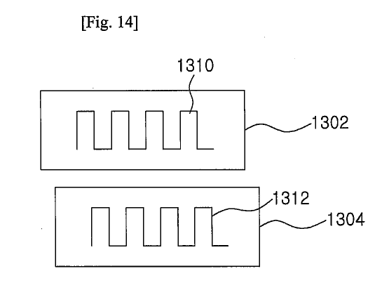

FIG. 14 illustrates patterns formed on boards according to an embodiment of the present invention.

Referring to FIG. 14, patterns of substantially the same shape can be formed on the first board 1302 and second board 1304, The patterns can be formed in various ways, such as by etching, printing, sputtering, etc.

While FIG. 14 an example in which patterns of a rectangular pulse type are used, the patterns are not thus limited, and any type of pattern can be used that is capable of generating an induced current.

As described above, an alternating current may be provided to a pattern on one of the first board and the second board, while no alternating current may be provided to a pattern on the other. While FIG. 14 illustrate an example in which continuous patterns are used, the patterns do not necessarily have to be continuous, and rectangular pulse patterns that are disconnected at some portions can be formed on the boards.

The load measurement according to an embodiment of the present invention can be achieved using either the magnitude of the induced current or the phase of the induced current. An appropriate type of pattern can be formed depending on which physical property is to be used.

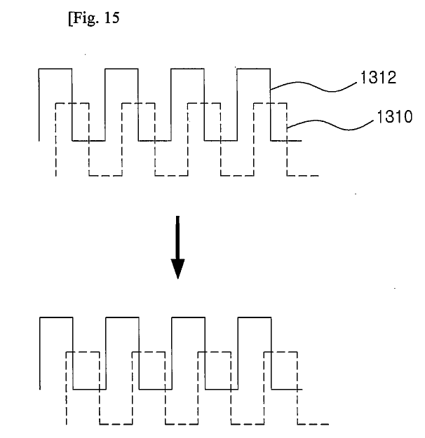

FIG. 15 illustrates position changes in the patterns formed on the first board and second board when a load is applied on a cantilever type elastic body according to an embodiment of the present invention.

In FIG. 15, a solid line is used to represent the second pattern 1312 on the second board, which is the fixed board, and a dotted line is used to represent the first pattern 1310 on the first board, which is the board that moves according to the deformation of the elastic body. It will be assumed that an alternating current is provided to and flowing through the pattern of the first board.

As illustrated in FIG. 15, when a load is applied, the first board may move upward, and the first pattern on the first board may move to the right in relation to the second pattern on the second board.

When the first board is moved as in FIG. 15, an electromagnetic interaction may occur between the first pattern of the first board and the second pattern of the second board, generating an induced current in the second pattern of the second board in which there was no current.

The second pattern on the second board where the induced current is generated may be electrically connected with a separate signal processing part.

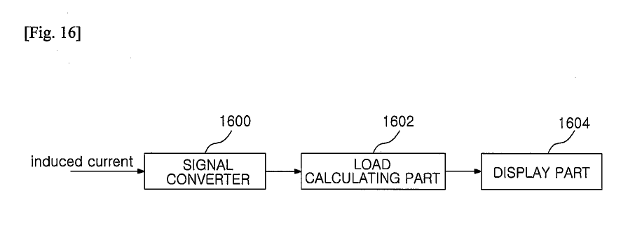

FIG. 16 is a block diagram representing the composition of a signal processing part according to an embodiment of the present invention.

Referring to FIG. 16, the signal processing part according to an embodiment of the present invention can include a signal converter part 1600, a load calculating part 1602, and a display part 1604.

The signal converter part 1600 may serve to convert the induced current signal into a pre-designated format. For example, the signal converter part 1600 may perform a process of signal conversion, by converting the induced current, which is an analog signal, into a digital signal and removing noise components. The signal converter part 1600 can also perform amplification for the induced current.

The load calculating part 1602 may calculate the load of the object using the signal outputted from the signal converter part. According to an embodiment of the invention, the load calculating part 1602 can calculate the load using a microprocessor. The load calculating part 1602 may calculate the load using the magnitude and phase information of the output signal from the signal converter part. The load calculating part can calculate the load using a pre-designated calculation algorithm and, if a high level of precision is not required, can calculate the load using a lookup table.

The display part 1604 may serve to display the load calculated by the load calculating part. Various display devices can be used, such as an LCD, LED, etc.

While the present invention has been described with reference to particular embodiments, it is to be appreciated that various changes and modifications may be made by those skilled in the art without departing from the spirit and scope of the present invention, as defined by the appended claims and their equivalents.

1. An elastic body for measuring a load, the elastic body comprising:
an elastic body base;
a plurality of slits formed in the elastic body base; and
a deforming space part formed in the elastic body base,
wherein the deforming space part includes therein:
a hinge; a first deforming part coupled with the hinge; and a second deforming part coupled with the first deforming part and the hinge, the second deforming part having a greater length than that of the first deforming part,
and the first deforming part and the second deforming part are configured to undergo rotational movements about the hinge in correspondence to the load, the first deforming part configured to move downwards in correspondence to the load and the second deforming part configured to move upwards in correspondence to the load, and an upward displacement of the second deforming part is used for measuring the load.

2. The elastic body for measuring a load according to claim 1, wherein the deforming space part is a hole formed in the elastic body base, and wherein the hinge, the first deforming part, and the second deforming part are formed inside the hole.

3. The elastic body for measuring a load according to claim 1, wherein the plurality of slits are formed in the elastic body base along a horizontal direction and includes a first slit, the first slit configured such that a deformation of the elastic body is not provided to the hinge when the load is applied.

4. The elastic body for measuring a load according to claim 3, wherein the plurality of slits include a second slit, the second slit extending vertically from the first slit.

5. The elastic body for measuring a load according to claim 4, wherein the plurality of slits include a third slit, the third slit separated from the second slit by a particular distance and formed vertically on the elastic body base.

6. The elastic body for measuring a load according to claim 5, wherein the second slit and the third slit are deformed in correspondence to the load when the load is applied and define a load transferring part, the load transferring part configured to transfer the load to the first deforming part.

7. The elastic body for measuring loads according to claim 6, wherein the load transferring part moves downward in correspondence to the load and is deformed to be perpendicular to the first deforming part.

8. The elastic body for measuring loads according to claim 6, wherein both ends of the second slit have rounded structures.

9. The elastic body for measuring loads according to claim 6, wherein the second slit, the third slit, and the load transferring part defined by the second slit and the third slit have indentations formed in portions thereof.

10. The elastic body for measuring loads according to claim 6, wherein the third slit has a hole formed in a lower end thereof.

11. A load-measuring device comprising:
an elastic body having a plurality of slits and a deforming space part formed therein, the deforming space part having a hinge, a first deforming part, and a second deforming part formed therein, the first deforming part coupled with the hinge, the second deforming part coupled with the first deforming part and the hinge and having a greater length than that of the first deforming part, wherein the first deforming part and the second deforming part are configured to undergo rotational movements about the hinge in correspondence to a load, the first deforming part configured to move downwards in correspondence to the load and the second deforming part configured to move upwards in correspondence to the load;
an arm coupled with the second deforming part of the elastic body along a lengthwise direction of the second deforming part;
a first board coupled to an end portion of the arm; and
a second board coupled to a securing element,
wherein electrical patterns are formed on the first board and the second board, and the load is measured using an induced current generated in an electrical pattern formed on one of the first board and the second board in correspondence to a movement of the first board.

12. The load-measuring device according to claim 11, wherein the deforming space part is a hole formed in the elastic body, and wherein the hinge, the first deforming part, and the second deforming part are formed inside the hole.

13. The load-measuring device according to claim 11, wherein the plurality of slits are formed in the elastic body along a horizontal direction and includes a first slit, the first slit configured such that a deformation of the elastic body is not provided to the hinge when the load is applied.

14. The load-measuring device according to claim 13, wherein the plurality of slits include a second slit, the second slit extending vertically from the first slit.

15. The load-measuring device according to claim 14, wherein the plurality of slits include a third slit, the third slit separated from the second slit by a particular distance and formed vertically on the elastic body.

16. The load-measuring device according to claim 15, wherein the second slit and the third slit are deformed in correspondence to the load when the load is applied and define a load transferring part, the load transferring part configured to transfer the load to the first deforming part.

17. The load-measuring device according to claim 16, wherein the second deforming part has at least one hole formed therein for coupling with the arm.

18. The load-measuring device according to claim 11, further comprising a support, the support having one end of the elastic body placed thereon, wherein the second board is immovably mounted on an arm extending from the support.
